(19) United States
(12) Patent Application Publication
(10) Pub. No.: US 2023/0387554 A1
(43) Pub. Date: Nov. 30, 2023

(54) BATTERY PACK BUS SYSTEMS

(71) Applicant: APPLE INC., CUPERTINO, CA (US)

(72) Inventors: Abraham B. Caulk, San Jose, CA (US); Alexander J. Clarabut, Santa Clara, CA (US); Dylan Erb, San Jose, CA (US); Nivay Anandarajah, San Leandro, CA (US)

(21) Appl. No.: 17/804,817

(22) Filed: May 31, 2022

(51) Int. Cl. H01M 50/507; H01M 50/516

(52) U.S. Cl. CPC H01M 50/507; H01M 50/516

(57) ABSTRACT

Battery packs according to some embodiments of the present technology may include a first end beam and a second end beam. The battery packs may include a plurality of battery cells disposed between the first end beam and the second end beam. Each battery cell of the plurality of battery cells may be separated from an adjacent battery cell by an interface material. Each battery cell may include a first terminal and a second terminal on a first surface of the battery cell. The battery packs may include a plurality of busbar segments electrically coupling each cell of the plurality of battery cells. The battery packs may include a bus tray including a plurality of bus tray segments. Each bus tray segment may seat at least two busbar segments. Each bus tray segment may extend at least partially across at least three battery cells of the plurality of battery cells.

### CROSS-REFERENCES TO OTHER APPLICATIONS

This application is related to the concurrently filed and commonly assigned U.S. nonprovisional patent application U.S. nonprovisional patent application Ser. No. ______, Filed May 23, 2022, “BATTERY PACK BUS SYSTEMS (Attorney Docket No. 1315433).

### TECHNICAL FIELD

The present technology relates to battery structures and systems. More specifically, the present technology relates to methods, systems, and components for providing bus networks for battery packs.

### BACKGROUND

Battery placement within a battery pack may be performed with many considerations. For example, battery configurations with compact placement of battery cells may provide increased energy density by allowing more battery cells within the pack. There are many thermal, structural, and mechanical challenges with the compact placement of cells.

### SUMMARY

Battery packs according to some embodiments of the present technology may include a first end beam and a second end beam. The battery packs may include a plurality of battery cells disposed between the first end beam and the second end beam. Each battery cell of the plurality of battery cells may be separated from an adjacent battery cell by an interface material. Each battery cell of the plurality of battery cells may include a first terminal and a second terminal on a first surface of the battery cell. The battery packs may include a plurality of busbar segments electrically coupling each cell of the plurality of battery cells. The battery packs may include a bus tray including a plurality of bus tray segments. Each bus tray segment may seat at least two busbar segments. Each bus tray segment may extend at least partially across at least three battery cells of the plurality of battery cells.

In some embodiments a battery pack comprises a first end beam, a second end beam and a plurality of battery cells disposed between the first end beam and the second end beam. Each battery cell of the plurality of battery cells is separated from an adjacent battery cell by an insulation material, and each battery cell of the plurality of battery cells includes a first terminal and a second terminal on a first surface of the battery cell. A plurality of busbar segments electrically couple each battery cell of the plurality of battery cells. A bus tray comprises a plurality of bus tray segments, wherein each bus tray segment seats at least two busbar segments, and wherein each bus tray segment extends at least partially across at least three battery cells of the plurality of battery cells.

In some embodiments, each bus tray segment seats a first busbar segment electrically coupling the first terminal of a first battery cell with the second terminal of a second battery cell, and each bus tray segment further seats a second busbar segment electrically coupling the first terminal of the second battery cell with a second terminal of a third battery cell. In various embodiments each battery cell of the plurality of battery cells is inverted along the first surface relative to an adjacent battery cell.

In some embodiments each bus tray segment is at least partially separated from an adjacent bus tray segment by a gap. In various embodiments each bus tray segment is coupled with an adjacent bus tray segment across the gap by an arcuate connector. In some embodiments each bus tray segment at least partially overlaps an adjacent bus tray segment. In various embodiments each bus tray segment defines an aperture for each terminal over which the bus tray segment is positioned.

In some embodiments each second terminal protrudes from the first surface of an associated battery cell, and each bus tray segment comprises a tab at each aperture associated with a second terminal, the tab configured to seat the bus tray segment about each associated second terminal. In various embodiments each busbar segment comprises a first terminal pad and a second terminal pad, and an aperture is defined through at least one of the first terminal pad and the second terminal pad. In some embodiments each busbar segment comprises a flexible section characterized by a bend defined by the busbar segment that protrudes from a surface of the busbar segment opposite a surface facing the plurality of battery cells.

In some embodiments each busbar segment comprises two flexible sections separated by a break through the busbar segment. In various embodiments the two flexible sections are laterally offset from each other. In some embodiments the two flexible sections are each oriented in a direction parallel to the first surface of a battery cell of the plurality of battery cells.

In some embodiments a battery pack comprises a first end beam, a second end beam, a first side beam extending between the first end beam and the second end beam and a second side beam extending between the first end beam and the second end beam and a base. The first end beam, the second end beam, the first side beam, the second side beam, and the base are welded along each interface between each component. A plurality of battery cells are disposed between the first side beam and the second side beam, wherein each battery cell of the plurality of battery cells is separated from an adjacent battery cell by an insulation material. Each battery cell of the plurality of battery cells includes a first terminal and a second terminal on a first surface of the battery cell. A plurality of busbar segments electrically couple each battery cell of the plurality of battery cells. A bus tray comprises a plurality of bus tray segments, wherein each bus tray segment seats at least two busbar segments, and wherein each bus tray segment extends at least partially across at least three battery cells of the plurality of battery cells. A lid is coupled with a surface of each battery cell of the plurality of battery cells facing the lid.

In various embodiments the battery pack further comprises a longitudinal beam extending between the first end beam and the second end beam, wherein the longitudinal beam is disposed between the first side beam and the second side beam. In some embodiments the plurality of battery cells comprise a first plurality of battery cells. The battery pack further comprises a second plurality of battery cells disposed between the second side beam and the longitudinal beam, wherein each battery cell of the second plurality of battery cells is separated from an adjacent cell by an insulation material.

In some embodiments the longitudinal beam is characterized by a first longitudinal surface and a second longitudinal surface opposite the first longitudinal surface, wherein the first surface of each battery cell of the first plurality of battery cells faces the first longitudinal surface of the longitudinal beam, and wherein the first surface of each battery cell of the second plurality of battery cells faces the second longitudinal surface of the longitudinal beam. In various embodiments each bus tray segment seats a first busbar segment electrically coupling the first terminal of a first battery cell with the second terminal of a second battery cell, and wherein each bus tray segment further seats a second busbar segment electrically coupling the first terminal of the second battery cell with a second terminal of a third battery cell. In some embodiments each bus tray segment is at least partially separated from an adjacent bus tray segment by a gap.

In some embodiments a battery pack comprises a first end beam, a second end beam, aa first side beam extending between the first end beam and the second end beam, a second side beam extending between the first end beam and the second end beam and a base. A plurality of battery cells are disposed between the first side beam and the second side beam, wherein each battery cell of the plurality of battery cells is separated from an adjacent battery cell by an insulation material. Each battery cell of the plurality of battery cells includes a first terminal and a second terminal on a first surface of the battery cell, wherein the first end beam and the second end beam maintain the plurality of battery cells compressed between the first end beam and the second end beam. A plurality of busbar segments electrically couple each battery cell of the plurality of battery cells. A bus tray comprises a plurality of bus tray segments, wherein each bus tray segment seats at least two busbar segments, and wherein each bus tray segment extends at least partially across at least three battery cells of the plurality of battery cells. A lid is coupled with a surface of each battery cell of the plurality of battery cells facing the lid.

Such technology may provide numerous benefits over conventional technology. For example, the present systems may increase volumetric energy density over conventional pack structures. Additionally, the present systems may incorporate battery busbar and bus structures that can accommodate compression and expansion of a number of battery cells without damaging the busbar coupling with the battery cells. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic exploded view of a battery pack according to some embodiments of the present technology.

FIG. 2 shows a schematic partial isometric view of battery pack housing components according to some embodiments of the present technology.

FIGS. 3A-3E show schematic views of processes coupling busbars with battery cells according to some embodiments of the present technology.

FIG. 4 shows a schematic view of a bus tray structure of a battery pack according to some embodiments of the present technology.

FIG. 5 shows a schematic view of a bus tray segment structure of a battery pack according to some embodiments of the present technology.

FIG. 6 shows a schematic view of a bus tray segment structure of a battery pack according to some embodiments of the present technology.

FIG. 7 shows a schematic isometric view of a busbar segment structure of a battery pack according to some embodiments of the present technology.

FIG. 8 shows a schematic view of a busbar segment structure of a battery pack according to some embodiments of the present technology.

FIG. 9 shows a schematic view of a busbar segment structure of a battery pack according to some embodiments of the present technology.

FIG. 10 shows a schematic view of a battery pack including a busbar assembly according to some embodiments of the present technology.

FIG. 11 shows a schematic view of a busbar assembly according to some embodiments of the present technology.

FIG. 12 shows a schematic view of a battery pack including a fully assembled busbar assembly according to some embodiments of the present technology.

FIG. 13 shows a method of forming a battery pack with a busbar assembly according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Battery packs may include any number of battery cells packaged together to produce an amount of power. For example, many rechargeable batteries may include multiple cells having any number of designs including wound, stacked, prismatic, as well as other configurations. The individual cells may be coupled together in a variety of ways including series connections and parallel connections. As increased capacity is sought from smaller form factors, battery cell configurations and packaging may play an important role in operation of the battery system under normal operating conditions as well as during abuse conditions.

For example, battery packaging may be used to limit the likelihood of cell damage, which may lead to short circuiting in some battery cell designs, and which may cause temperature increases initiating exothermic reactions leading to thermal runaway. Regardless of the initiation mechanism, once begun, the result is often continuous heat generation until reactions have consumed the cell material. When battery cells are placed within a pack design, adjacent cells may be exposed to high temperatures from neighboring cells undergoing failure events. Should this exposure occur over a sufficient time period, the internal temperature within the adjacent cell may exceed the threshold for thermal runaway, extending the failure to the adjacent cell. This process may then continue across each cell within the pack, eventually consuming the majority of cells, if not every cell. Additionally, when battery packs are used in devices that may be dropped, impacted, pierced, or otherwise damaged, the battery pack and constituent cells may also be damaged, which may cause similar issues to occur.

Conventional packs have attempted to control failure spread of this nature by isolating cells, incorporating extensive insulation, or increasing the separation of cells from one another. Although this may provide additional protection from cell failure spreading to adjacent cells, this may also limit capacity of a battery pack below some system requirements. To address impact and other damage, conventional technologies may further insulate and isolate the battery cells from a housing or structural support, which may further reduce capacity or energy density of the battery pack. Additionally, many conventional pack designs may utilize modules containing a number of cells, which may be positioned within a battery pack housing. These modules may be formed to apply a force to compress the battery cells, which may help maintain lamination of cell components as well as performance over time by limiting cell swelling. However, these modules may consume significant space within a battery pack, which may increase the weight of the pack, as well as reduce the volumetric energy density of the produced battery pack.

The present technology overcomes these issues by creating systems that incorporate the battery cells within the structure to facilitate load distribution for many different abuse events. By incorporating the battery cells directly with the overall pack structural supports, housing and enclosure components may be reduced, which may allow increased volumetric density and specific energy for the battery pack, and which may provide a more compact and robust design compared to conventional systems. Advantageously, by incorporating components in a space efficient manner, the present technology may utilize less insulation due to the inherent heat spreading of coupling the cells directly to the enclosure. The present technology may also produce structurally superior housing with improved sealing compared to previous designs, and which may be used to apply the compressive force to batteries without the need for modules.

By utilizing the enclosure to apply compression to the battery cells, incorporated components may also be compressed during incorporation. While many components may be configured or designed to accommodate an amount of compression, busbars and associated components in the back may be more rigidly designed and fixed within the system. Compression on the battery cells may cause welds to fracture, or busbars to snap from cell terminals. The present technology may utilize busbars and bus systems configured to accommodate an amount of compression, while maintaining welds and other coupling to associated battery cells within the pack.

Although the remaining portions of the description will routinely reference lithium-ion or other rechargeable batteries, it will be readily understood by the skilled artisan that the technology is not so limited. The present techniques may be employed with any number of battery or energy storage devices, including other rechargeable and primary, or non-rechargeable, battery types, as well as electrochemical capacitors also known as supercapacitors or ultracapacitors. Moreover, the present technology may be applicable to batteries and energy storage devices used in any number of technologies that may include, without limitation, phones and mobile devices, handheld electronic devices, laptops and other computers, appliances, heavy machinery, transportation equipment including automobiles, water-faring vessels, air-travel equipment, and space-travel equipment, as well as any other device that may use batteries or benefit from the discussed designs. Accordingly, the disclosure and claims are not to be considered limited to any particular example discussed, but can be utilized broadly with any number of devices that may exhibit some or all of the electrical or other characteristics of the discussed examples.

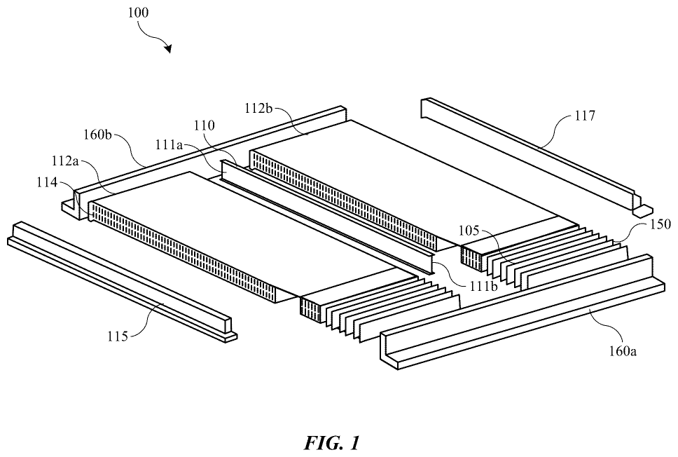

FIG. 1 shows a schematic exploded view of a battery pack 100 according to some embodiments of the present technology. Battery pack 100 includes a number of battery cells 105 distributed in rows along either side of a longitudinal beam 110. The battery cells 105 may be separated from one another by longitudinal beam 110 into two rows extending the length of the battery pack. In some embodiments a number of longitudinal beams may be included within the battery pack where additional structural support or larger form factors are produced. The longitudinal beams may provide structural integrity to the battery pack and may provide protection for battery terminals and battery coupling. As illustrated, battery pack 100 includes two sets of battery cells 105, including a first set 112a of battery cells 105, and a second set 112b of battery cells 105.

As shown, first set 112a of the battery cells may extend outward from a first longitudinal surface 111a of the longitudinal beam 110, and second set 112b of the battery cells may extend outward from a second longitudinal surface 111b of the longitudinal beam 110, which may be opposite the first longitudinal surface. The battery cells 105 may be reversed in orientation between the two sets, which may orient the battery terminals for all cells to be facing the longitudinal beam 110. For example, with respect to the second set 112b, the individual cells may be oriented so that the battery terminals 113 of each battery cell may be facing longitudinal beam 110, such as along second surface 111b. The same type of orientation may be provided with the first set of battery cells 112a, where the terminals may all face the first surface 111a of longitudinal beam 110. The battery cells may also be formed so that each cell may have a vent 114 on an opposite side of the cell from the terminals, and which may face an associated side beam as discussed further below.

Along surfaces of the battery cells opposite surfaces facing the longitudinal beam may be side beams. For example, a first side beam 115 may be positioned adjacent each battery cell of the first set 112a of the battery cells, and a second side beam 117 may be positioned adjacent each battery cell of the second set 112b of the battery cells. A lid may be coupled overlying the battery cells, which may be seated on a base. In some embodiments, lid may act as a structural member providing structural attachments to a system in which the battery pack is incorporated. As will be described further below, adjacent battery cells may alternate vertical location of the vent. For example, a first battery cell may include a vent 114 formed within a surface of the battery cell facing the side beam 115, with the vent formed proximate a top surface of the battery cell, such as facing the lid, and which may be in line with a first plenum formed in the side beam. Additionally, an adjacent battery cell may include a vent formed within a surface of the battery cell facing the side beam 115, with the vent formed proximate a bottom surface of the battery cell, such as facing the base, and which may be in line with a second plenum formed in the side beam. By alternating vent locations between adjacent batteries, a lower heat impact may be provided to adjacent battery cells during a particular abuse event. The first plenum and the second plenum may be fluidly isolated from one another by a cross-member in the side beam, which may further limit impact if two adjacent batteries exhaust heated effluent materials by separating the materials from one another within the side beam.

As illustrated, battery packs according to some embodiments of the present technology may not include additional housing separating the battery cells from the structural supports of the battery packs, although one or more spacers may be included in some locations. Many conventional battery packs may isolate the battery cells in modules that then may be incorporated within a structural setup for the battery pack. Because such modules may be characterized by specific geometries, the resulting battery packs may inefficiently utilize space, and may maintain a number of gaps about the structural members. The present technology may utilize alternative battery geometries and materials, which may be utilized directly with the pack structure to provide further reinforcement of the overall battery pack, as well as for the system in which the battery pack may be incorporated. For example, although battery cells encompassed by the present technology may be characterized by any dimensions, battery cells according to some embodiments of the present technology may be characterized by lateral dimensions, such as extending orthogonally to a length of longitudinal beam 110, of greater than or about 10 cm, and may be characterized by lateral dimensions greater than or about 20 cm, greater than or about 30 cm, greater than or about 40 cm, greater than or about 50 cm, greater than or about 60 cm, greater than or about 70 cm, greater than or about 80 cm, greater than or about 90 cm, greater than or about 100 cm, or more. Accordingly, each battery cell may extend from the longitudinal beam 110 to an associated side beam.

In many conventional designs, insulation may be provided along all sides of each cell or module to assist in controlling heat dissipation to adjacent cells. However, because of the rapid generation of heat during failure events, the heat transferred to adjacent cells may still be sufficient to raise internal temperatures of the adjacent cells above the threshold to initiate thermal runaway in the adjacent cells as well. Because of the insulation extending around the cells, the distribution of heat to the immediately adjacent cells may be substantially uniform, and the amount of heat generated in thermal runaway may cause internal temperatures of each adjacent cell to increase above the thermal runaway threshold. Consequently, many conventional designs may be limited to less compact configurations incorporating additional and thicker insulation and module designs that incorporate more battery cell separation.

The present technology may utilize battery cells in some embodiments that may be characterized by a slower reaction during failure events, or by a lower rate of degeneration of the cell materials. For example, during a failure event, reactions consuming active materials within the cell may be controlled based on the chemical makeup of the cells to slow the reaction, which may reduce the temperature of an event. Consequently, a peak temperature during failure may be maintained below or about 1,000° C., and may be maintained below or about 900° C., below or about 800° C., below or about 700° C., below or about 600° C., below or about 500° C., below or about 400° C., or lower. This may limit impact on adjacent cells, which may otherwise be unable to survive higher temperatures that may cause thermal runaway of adjacent batteries. Accordingly, batteries may be spaced closer together, or with less insulation between adjacent batteries in some embodiments of the present technology.

By disposing the battery cells against the surrounding structural components, heat transfer from the battery cells may be further improved and less insulation may be incorporated within the pack, which may further improve volumetric energy density. For example, in some embodiments lid may be coupled with a first surface of each battery cell 105 utilizing a thermal interface material and/or adhesive. Thermal interface material may directly contact each battery cell 105 of both sets or all sets, and may contact lid on an opposite surface. Similarly, in some embodiments base may be coupled with a second surface of each battery cell 105 opposite the first surface. The base may be coupled with the battery cells using a thermal interface material and/or adhesive. Again, thermal interface material may directly contact each battery cell 105 of the battery pack, and may contact base on an opposite surface. Base may be or include a heat exchanger, and thus, more direct contact between the battery cells and the base may further facilitate heat transfer from battery cells during operation.

A compliant pad 150 may be positioned between each battery cell and adjacent battery cells, in some embodiments of the present technology, although thermally conductive adhesives or thermal barriers may also be used between some cells. For example, in some embodiments some adjacent cells may include a compliant pad disposed between them, and some adjacent cells may include a thermal barrier material disposed between them. The materials may be included in any combination with each other, such as more of one or the other, where one material may be included every other cell, every third cell, every fourth cell, or further distributed, while the other component is included between each other cell pair. In some embodiments the battery pack 100 may have 20 or more battery cells, 40 or more battery cells, 60 or more battery cells, 80 or more battery cells, 100 or more battery cells, 150 or more battery cells or 200 or more battery cells 105. As battery cells are cycled during their life, the cells may swell over time as well as during normal operation as the cell heats. When cells are rigidly compressed or contained within a particular structure, the cells may have reduced cycle life. The present technology, however, may include compliant pads or insulation configured to provide an amount of deflection or compression to accommodate swelling of battery cells over time, as well as to reduce or limit heat transfer between adjacent cell blocks. The compliant pads 150 may be configured to fully occupy space between each battery cell to limit any gaps within the structure. However, the compliant pads may be configured to accommodate compression of up to 20%, 30%, 40%, 50%, 60% or 80% or more, or between 20% and 60% or between 30% and 50% or between 30% and 40% of the pad thickness to accommodate battery swelling over time. In some embodiments each compliant pad 150 may be arranged to deflect between 0.1 and 1.5 mm, between 0.2 and 0.7 mm, between 0.3 and 0.4 mm, approximately 0.3 mm or approximately 0.4 mm. Unlike conventional technology that may not provide such accommodation, the present technology may produce longer battery life cycles based on the incorporated accommodation of battery swelling within each cell block, and may accommodate cell thickness tolerance. Additionally, the compliant material or materials may facilitate cell incorporation in sealed housing structures as will be described further below.

Between each side beam and the battery cells, a sealing foam or pad may be incorporated, which may ensure complete seating of the side beam and the battery cells, and limit or prevent any gaps between the components. The housing may also include an end beam, which may be coupled against the battery cells at longitudinal ends of the battery pack to complete the pack structure. As illustrated, the end beams 160 may be formed fully between side beams, where the longitudinal beam may be coupled against an interior surface of the end beams. This may allow a battery set to be disposed in a partially constructed housing as described further below, which may increase sealing capabilities of the housing, and an ability to apply a compressive force against the battery cells.

The compliant pads 150 and/or sealing foam, as well as insulation discussed further below, may be intended to reduce heat transfer and afford an amount of compression, and may be characterized by a thermal conductivity of less than or about 0.5 W/m·K, and may be characterized by a thermal conductivity of less than or about 0.4 W/m·K, less than or about 0.3 W/m·K, less than or about 0.2 W/m·K, less than or about 0.1 W/m·K, less than or about 0.05 W/m·K, or less. The pads may be or include any number of insulative materials, and may include thermally resistive blankets, mats, microporous materials, and other materials that may include oxides of various metals, as well as other insulative materials that may contribute to any of the thermal conductivity numbers stated. Because of the distribution of heat away from adjacent cells, the present technology may facilitate a reduction in insulation between cells. For example, in some embodiments the amount of insulation provided between each battery cell may be less than or about 2 cm in thickness, and may be less than or about 1 cm, less than or about 8 mm, less than or about 6 mm, less than or about 5 mm, less than or about 4 mm, less than or about 3 mm, less than or about 2 mm, or less in some embodiments. The reduced insulation may contribute additional volume in a battery pack, which may be used to incorporate additional or larger battery cells, increasing overall capacity.

The thermal interface material and/or thermal interface material may be intended to increase heat transfer, and may be characterized by a thermal conductivity of greater than or about 0.5 W/m·K, and may be characterized by a thermal conductivity of greater than or about 1 W/m·K, greater than or about 2 W/m·K, greater than or about 5 W/m·K, greater than or about 10 W/m·K, greater than or about 25 W/m·K, or greater. The thermal interface materials may be or include any number of thermally conductive materials, and may include thermal pastes or grease, polymeric, or other conductive materials. In some embodiments the thermal interface material may not be electrically conductive, for example. In some embodiments, because the surface of the cell block may not be electrically charged, an electrically conductive paste, which may also increase thermal conductivity, may be used. Additionally, material and/or material may be a structural adhesive in addition to or as an alternative to a thermally conductive adhesive. This may increase overall packaging efficiency within the pack. By utilizing the thermal interface materials to facilitate heat transfer away from the battery cells of the battery pack, the amount of insulation utilized may be reduced as battery cell temperature may be maintained at lower temperatures, and which again may increase the useable space within a battery pack for battery cells.

The longitudinal beams, side beams, end beams, as well as the lid and/or base, may be made of any number of materials, and may act as structural members of the battery pack 100. Accordingly, the materials may be or include aluminum, steel, plastic materials, or composite materials providing some balance between strength, rigidity, and flexibility. The longitudinal beams and lateral walls may also provide an amount of heat conduction away from battery cell blocks that are in fault or other abuse conditions, including thermal runaway. The longitudinal beam may be an I-beam in some embodiments of the present technology. While this may create recessed space along the length of the beams, this space may be used to accommodate aspects of the present technology. For example, as noted above, the recessed space may accommodate busbar and other connection materials that couple with the battery terminals.

Battery pack housing in many configurations may be coupled in any number of ways, including adhesives, bonding, mechanical joining, or some combination. While cylindrical battery cells, and many primary batteries, may constitute a pressure vessel that can accommodate cell expansion, prismatic batteries often have an amount of counter pressure applied against them to limit swelling and maintain component lamination. Accordingly, when housing components are utilized to exert this pressure, the housing components are typically joined one component at a time, and used to apply pressure. This proximity to the battery cells themselves may limit the types of joining available. For example, welding may not be utilized due to heat or energy dissipation proximate the battery cell walls, which may cause damage. Even with more conventional modules used in packaging, the housing may be produced without welding to limit the possibility of cell damage, which can be even more detrimental in modular packaging as it can lead to scrapping an entire module due to damage of a single cell. However, adhesive and mechanical joining of components may cause multiple issues, including lack of hermetic sealing of the housing, and joint integrity. While mechanical joining may improve joint integrity, sealing is more difficult. Similarly, while adhesives may improve sealing, when vertical and horizontal seals intersect, integrity may be limited as the formation of one seal may cause damage or loss of strength to an adjacent seal.

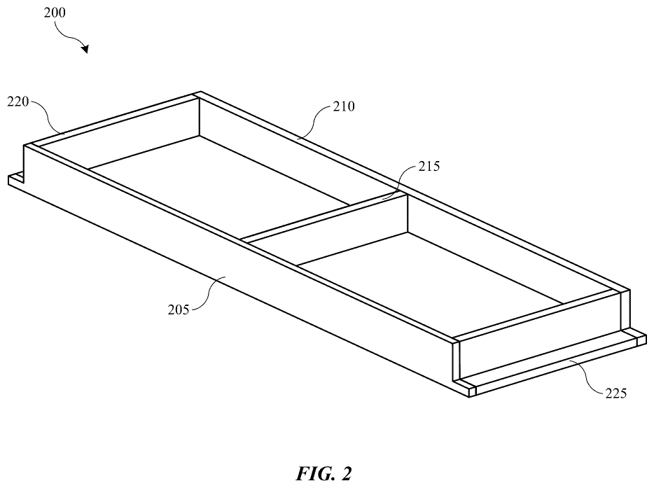

The present technology overcomes these issues in some embodiments by joining some or all of the housing components prior to installation of the battery cells. While this may occur with modular housings, the structure is necessarily less volume efficient, as the modules cannot be compressed, and thus the battery pack must maintain gaps sufficient to overcome any tolerance issues. The present technology, however, may utilize packaging processes to allow the battery cells to be seated within a housing that has been fabricated to apply a compressive force against the batteries. FIG. 2 shows a schematic partial isometric view of components of battery pack housing 200 according to some embodiments of the present technology, where some of the housing components may be pre-joined prior to installation of the battery cells, including components intended to apply a compressive pressure to the cells. For example, the two end beams may apply a compressive force against the battery cells, and in some embodiments, these components may already be joined with the base and/or other components prior to disposing the battery cells within the housing.

As illustrated, battery pack housing 200 may include components discussed above, such as a first end beam 205, a second end beam 210, a longitudinal beam 215, a first side beam 220, and a second side beam 225. Any number of additional side and/or longitudinal beams may be included to allow the incorporation of additional battery cell sets as discussed above. Any of these components may include any of the features, components, materials, or characteristics of any of the components discussed above. In some embodiments, each of these components may be joined with any other of these components to produce a housing substrate. Additionally, by forming the housing, such as every component but the lid, or every component but the base, or every component but one end beam used to apply compression, prior to installing the battery cells, improved structural integrity may be afforded by allowing any type of joining to be performed. For example, on one or more interfaces, including along every interface between the components, the components may be welded or bonded.

Although adhesives and/or mechanical joining, such as bolts, screws, or any other type of fastener, may be utilized on one or more interfaces including in addition to welding or bonding, in some embodiments, adhesives and/or mechanical joining may not be included to couple one or more interfaces, including any interface, such as vertical interfaces, including between the longitudinal beam and end beams or between the end beams and the side beams, as well as any horizontal interface, such as any interface with the base. This may allow more structural resiliency to be provided, and may ensure hermetic sealing between the components. Because the lid, or base in other embodiments, may be applied subsequent to incorporating the battery cells, the lid may be adhered and/or mechanically coupled with the other housing components, which may protect the battery cells from welding or other heat or arc-based coupling. Although embodiments of the present technology may include one or more welded components in the housing, the present technology may also encompass housing where one or more components, such as an end beam, may be bolted or otherwise coupled with the side beams, which may enable the end beam to be applied to compress battery cells disposed within the housing structure.

Because the housing may be used to apply a compressive force to the battery cells in some embodiments of the present technology, the housing components may be spaced to ensure a compressive force may be applied. As explained above, the first end beam and the second end beam may be spaced across the base at a distance configured to apply a compressive force against the battery cells, and which may be a distance less than an uncompressed distance of the battery cells. For example, a plurality of battery cells, which may be a set of battery cells as described above, may be characterized by a length of the battery cells to be incorporated in a direction between the first end beam and the second end beam, which may be greater than the distance between the welded first end beam and second end beam on the base. It is to be understood that battery cells may also include intervening materials, such as compliant pads and/or thermal barrier or interface materials as discussed above. Accordingly, in some embodiments, the battery pack may be compressed in order to be disposed within the battery pack housing. Additionally, in some embodiments, the sides, base, and one end beam may be formed and the battery cells incorporated in the structure. A second end beam may then be coupled and used to apply a compressive force against the battery cells.

In either scenario, the battery cells may include a number of additional components incorporated with the battery cells, and which may include sensing and other connection components, including busbars and associated materials. Battery packs according to embodiments of the present technology may include tens, hundreds, thousands, or more cells within each battery or within the battery pack. Busbars welded or otherwise joined to multiple cells or batteries may include rigid bodies to ensure sufficient current and voltage may be managed, and to limit resistance gains. However, these components in conventional forms may not be amenable to compression of the battery cells, either to drop in a formed housing, or by using an end beam to compress the cells. The force applied may cause excessive shear stress on weld or coupling points, and can cause the busbars to break from the cells. The present technology overcomes these issues by utilizing busbars and bus trays that can accommodate compression and expansion with the battery cells.

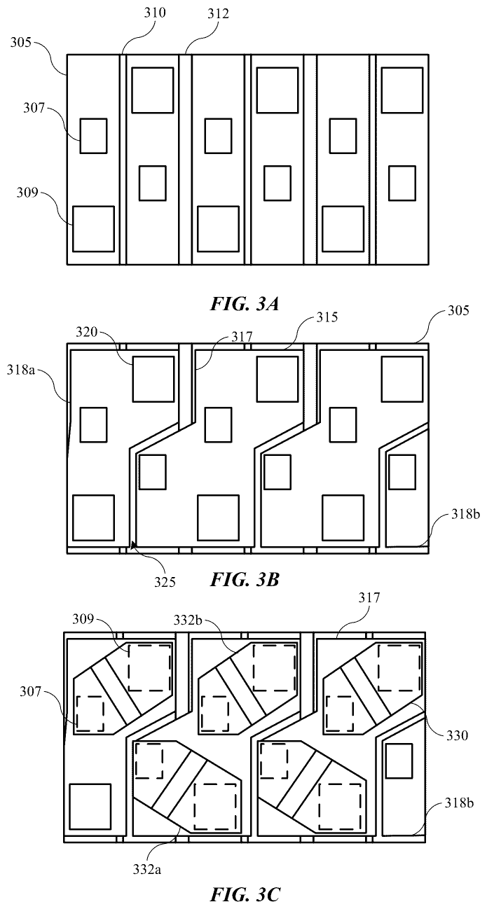

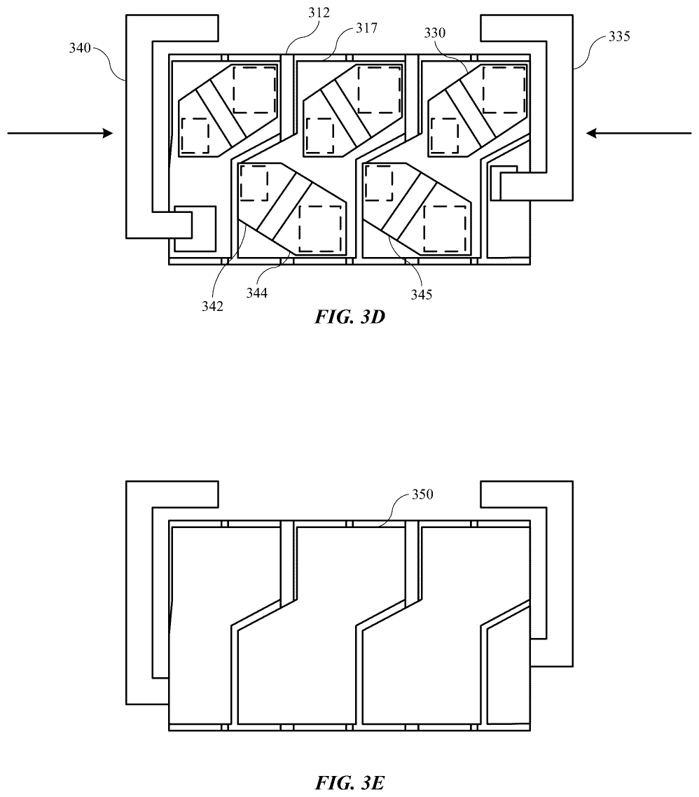

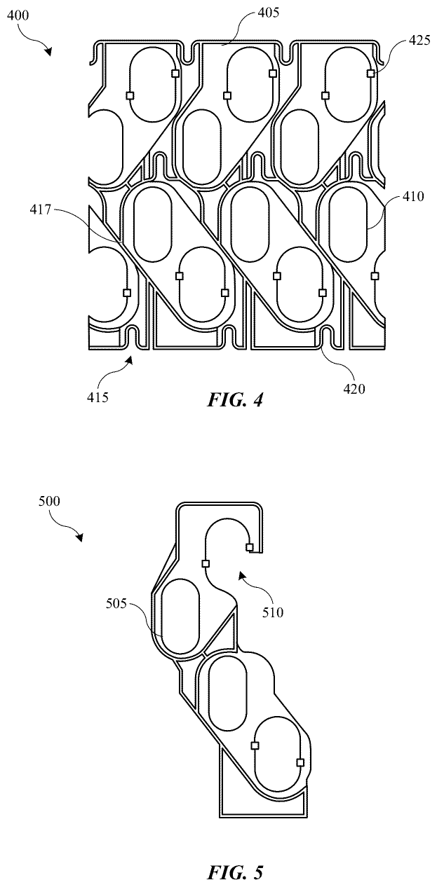

Turning to FIGS. 3A-3E are shown schematic views of battery cells and bus components, as well as processing operations for producing battery structures according to some embodiments of the present technology. The components may include any feature, aspect, or material of battery cells or components as discussed above, and may illustrate additional details of components of the battery packs described previously. As shown in FIG. 3A, battery packs may include a number of battery cells 305, which may include any type or number of cells in some embodiments. Each cell 305 may be characterized by a number of surfaces as previously described, including a first surface as illustrated, and which may include accessible battery terminals that can include a first terminal 307 and a second terminal 309. Although only six battery cells are illustrated in the figure, it is to be understood that any number of cells may be included in battery packs according to embodiments of the present technology.

The batteries may be oriented in the same or different directions in embodiments encompassed by the present technology. For example, while the batteries may all be oriented in the same direction, in some embodiments each battery cell may be oriented in a reverse or inverted direction, or flipped along the first surface, compared to an adjacent battery cell as illustrated in the figure. This may allow closer coupling of the terminals in some embodiments, and facilitate series connections, for example. The terminals may be offset from center as shown, which may further facilitate couplings as discussed further below. First terminal 307 and second terminal 309 may be either an anode or a cathode terminal in embodiments of the present technology, and may be formed in any number of ways. For example, although each terminal may be connected to electrode tabs separately, in some embodiments, the battery cells 305 may be at anode or cathode potential. Accordingly, one of the terminals, such as the first terminal 307, may be a landing pad on the first surface of the cell, and corresponding electrode tabs may be coupled with the pad or elsewhere on the housing. Additionally, one of the terminals, such as the second terminal 309, may be electrically isolated from the housing, such as having an isolator separating the terminal from the rest of the battery cell housing. It is to be understood that any number of electrode couplings are encompassed and may be utilized with aspects of the present technology.

As noted above, each battery cell 305 may be separated from an adjacent battery cell by an insulation material, which may be the same or different in embodiments encompassed by the present technology. For example, while some cells may be separated by a thermal barrier material 310 as discussed above, some cells may be separated by a compliant pad 312, also discussed above, and which may also be characterized by insulative properties, for example. As one non-limiting example, in some embodiments the insulation materials may alternate between a thermal barrier material, such as a microporous insulation, and a compliant pad. Because the battery cells may be compressed laterally inward, the compliant pads may be configured and sized to accommodate the majority of the compression, with the thermal barrier material and the battery cells accommodating less compression.

Embodiments of the present technology may utilize busbars and structures that may allow an amount of compression corresponding to compression of the battery cells. Instead of utilizing busbars and trays that extend across all battery cells in a stack, the present technology may utilize components that span a subset of the stack of cells, and may incorporate one or more gaps to accommodate compression. As shown in FIG. 3B, bus systems according to embodiments of the present technology may include bus trays 315 that include a number of bus tray segments 317. Each bus tray segment may be formed to seat one or more, including at least two, at least three, at least five, at least ten, at least twenty, at least fifty, or more busbar segments. Depending on the number of cells, and the amount of compression, bus trays may include more or less bus tray segments, and which can include more or less busbar segments. As one non-limiting example, with larger stacks including more compliant pads, bus trays may extend across more battery cells, as each cell or compliant pad may accommodate less of the overall compression, compared to systems where fewer pads would be used to accommodate greater compression distances.

In some embodiments as shown, each bus tray segment 317 may extend across at least two or more battery cells 305, and may extend across at least three or more battery cells, at least five or more battery cells, at least ten or more battery cells, at least fifteen or more battery cells, at least twenty or more battery cells, or more. Each bus tray segment 317 may be similar or identical across the battery stack, although in some embodiments one or more end pieces, such as end piece 318a or 318b, may be sized or formed to accommodate less terminals than bus tray segments across internal battery cells of the stack. Throughout this disclosure, end pieces may or may not be considered bus tray segments, although they may accommodate one or more bus features, such as end busbars as discussed below. Each bus tray segment 317 may define one or more apertures 320, which may correspond to battery cell terminals. For example, each bus tray segment may define an aperture for each terminal over which the bus tray segment is positioned. Additionally, each bus tray segment 317 may be at least partially separated from an adjacent bus tray segment by a gap 325 between each segment. The gaps may be consistent along an edge of each bus tray segment, or the gap may be characterized by a changing gap distance as shown in the figure.

Each bus tray segment 317 may define features or recesses that may seat busbar segments in some embodiments. As illustrated in FIG. 3C, busbar segments 330 may be disposed on or seated in each bus tray segment 317, although some end pieces may not include a busbar segment, such as end piece 318b, for example. Busbar segments 330 may be coupled with battery cell terminals, shown hidden in the figure, and may be connected by welding or any other coupling mechanism or material. The busbar segments may electrically couple each battery cell of the plurality of battery cells 305, and may be used to connect cells in series, as illustrated, or in any other configuration, according to some embodiments of the present technology.

As one non-limiting example of the present technology, and as illustrated in the figure, by inverting alternating battery cells, series connections may be more readily produced. As shown, each busbar segment may electrically couple a first terminal 307 of a first battery cell with a second terminal 309 of a second battery cell. Each bus tray segment may also seat a number of busbar segments across any number of battery cells, as noted above. As illustrated, each bus tray segment, which may include the end pieces or may not include the end pieces as illustrated, may seat two busbar segments, extending across three battery cells. For example, each interior bus tray segment, or bus tray segments not including end pieces, may seat a first busbar segment 332a that electrically couples a first terminal of a first battery cell with a second terminal of a second battery cell adjacent to the first battery cell. The bus tray segments may also seat a second busbar segment 332b that electrically couples a first terminal of the second battery cell with a second terminal of a third battery cell adjacent to the second battery cell.

Although the first busbar segments and the second busbar segments may be identical or mirror images of each other, in some embodiments the first busbar segments may be sized differently from the second busbar segments. For example, as illustrated, in embodiments in which alternating thermal barrier material and compliant pad material is disposed between the battery cells, the distance between battery cell terminals may not be consistent. For example, as shown in the figure, first busbar segment 332a may extend between two battery cell terminals where a compliant pad is disposed between the battery cells. However, second busbar segment 332b may extend between two battery cell terminals where a thermal barrier material is disposed between the battery cells. In some embodiments, the compliant pad may be at least 50% thicker than a thermal barrier material, and may be at least 75% thicker, at least 100% thicker, at least 150% thicker, at least 200% thicker, or more. Accordingly, the first busbar segments may extend a greater distance than the second busbar segments in embodiments of the present technology. As will be discussed further below, flexible sections may also be adjusted between the busbar segments to accommodate different compression.

As illustrated in FIG. 3D, one or more busbars may be connected to the battery stack of cells, which again may include any number of cells. A first busbar 335 may be coupled electrically with a first terminal, and a second busbar 340 may be coupled electrically with a second terminal. This may provide a negative connection and a positive connection across the battery stack. Although the end busbars are illustrated as coupled at far ends of the battery stack, any number of configurations are encompassed by the present technology, including having a half-pack connection, or less, which can allow the voltage across the pack to be reduced, for example. The end busbars may extend above the battery pack, as shown, or may extend to any other location that can allow system connections to be made.

The battery pack may be compressed laterally, such as shown by the arrows, at any number of times during the production of the pack. For example, an amount of compression may be applied prior to welding or joining the busbar segments with the battery cells, and only final compression may be applied, or over compression to allow seating in a housing may be applied once the busbars are connected. Additionally, all compression may be applied subsequent to connecting the busbar segments in some embodiments, such as where an end beam may apply pack compression as it is connected to other housing components. Compliant pads 312 may accommodate much of the compression within the battery cell stack, with thermal barrier materials and battery cells accommodating a lesser amount, or a minor amount. Bus tray segments 317 may accommodate compression by moving with the battery cells and closing some or all of the gap between segments. However, busbar segments 330, which span between battery cells, may accommodate compression by flexing in one or more locations.

As shown in the figures, each busbar segment 330 may include a first terminal pad 342, which may provide a surface for coupling with a first terminal of a battery cell. Each busbar segment may also include a second terminal pad 344, which may provide a surface for coupling with a second terminal of a battery cell. Additionally, each busbar segment may include a flexible section 345 allowing the busbar segment to compress or bend at or about the flexible section, and accommodate compression. Flexible section 345 may be characterized by a number of shapes as discussed further below, and may allow the first terminal pad and the second terminal pad to move closer together or further apart to accommodate compression, while limiting stress on weld points or other coupling materials or components. Each busbar segment may have a similar flexible section 345, although in some embodiments first busbar segments as discussed above may include a more pronounced or accommodating flexible section. Because the first busbar segments may extend across the compliant pads, and because the compliant pads may accommodate more of the compression, the flexible sections of the first busbar segments may be increased in size or flex potential to accommodate greater compression at those locations.

FIG. 3E shows bus trays including an optional cover 350, which may correspond to each bus tray segment. The covers may be attached to enclose the busbar segments, as well as to reduce or limit exposure of the first surface of each battery cell including the cell terminals. Incorporating covers may provide a system having surfaces that may have controlled access for electrically active components. This may facilitate fabrication and incorporation of battery cell stacks allowing touch-capable surfaces, and providing environmental protection of the busbar segments and battery cell terminals, which may be housed within the bus tray segments and covers. When used, the covers may snap or otherwise connect to the bus tray segments to secure the covers in place.

FIG. 4 shows a schematic view of a bus tray structure 400 of a battery pack according to some embodiments of the present technology. Bus tray structure 400 may include any of the features, aspects, or components of structures described previously, and bus tray structure 400 may be incorporated with any of the battery cell stacks or in any of the battery packs previously described. As shown, bus tray structure 400 may include a number of bus tray segments 405, which may accommodate a number of busbar segments as previously described. Each bus tray segment may define apertures 410, which may provide access to battery cell terminals for coupling busbar segments as discussed above. Bus tray segments 405 may be at least partially separated from one another by a gap 415, although bus tray structure 400 may illustrate a more compact design in which sections 417 may overlap an adjacent bus tray segment. During compression, sections 417 may extend over a portion of an adjacent bus tray segment to allow the segments to be closer together, while still affording compression accommodation.

Bus tray structure 400 also shows additional features that may be included with any of bus trays according to embodiments of the present technology, and may be included with any bus tray or bus tray segment discussed elsewhere. Bus tray structure 400 may illustrate an embodiment for which some or all of the bus tray segments are coupled together. This may facilitate assembly where a single tray component may be used. Each bus tray segment 405 may be coupled with an adjacent bus tray segment across the gap by one or more connectors 420. The connectors may be characterized by a bend or an arcuate shape of some type, which may allow the connector to bend inward or flex during compression operations. The connectors 420 may be the only locations connecting adjacent bus tray segments, in some embodiments, which may allow section 417 of each bus tray segment to overlap an adjacent segment during compression.

Bus tray structure 400 may also show locator tabs 425, which may be included at some or all apertures 410 of the bus tray segments. As explained above, in some embodiments, battery cells may include a first terminal connected to the cell housing, which may be maintained at either cathode or anode potential. In these configurations, the second terminal may be electrically isolated from the rest of the housing, such as with an isolator or insulative grommet component. To accommodate the isolator, the second terminal may extend proud of the first surface of the battery cell, and may protrude outward from the surface. Locator tabs 425 may snap about the second terminal or the isolator in some embodiments of the present technology. This may allow each bus tray segment to be held in position during assembly, and may allow the tray segments to seat busbar segments more accurately with the associated cell terminals.

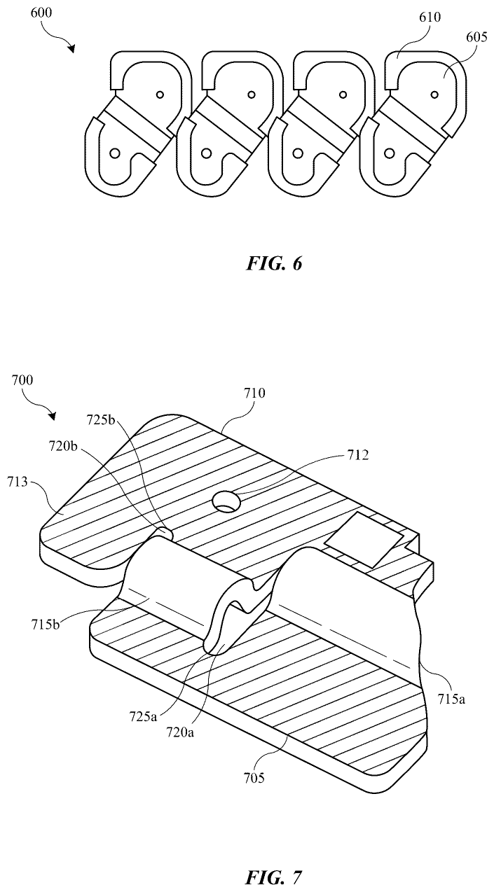

FIG. 5 shows a schematic view of a bus tray segment structure 500 of a battery pack according to some embodiments of the present technology. The tray segment may include any feature, aspect, or material previously described, and may be included in any battery pack or structure discussed above. Bus tray segment structure 500 may be characterized by a segment configuration similar to bus tray structure 400, although the structure may not have connected segments. Bus tray structure 500 may include individual tray segments, which may be snap fit on associated terminals utilizing locator tabs as discussed above. Although the individual segments may increase part count for assemblies, the structure may reduce material costs compared to some other configurations. Additionally, bus tray segment structure 500 illustrates a configuration for which at least one of the apertures 505 formed in the segment may be incompletely formed, as shown by spacing 510. This may facilitate assembly, and operate as a hook feature about a battery cell terminal. Any number of partially formed apertures may also be included to further reduce material used in bus tray assemblies according to embodiments of the present technology.

FIG. 6 shows a schematic view of a bus tray segment structure 600 of a battery pack according to some embodiments of the present technology. The tray segment may include any feature, aspect, or material previously described, and may be included in any battery pack or structure discussed above. Bus tray segment structure 600 may include individually overmolded busbar segments 605 that may then be individually welded or joined to the battery cell terminals. Overmolded portions 610 may comprise a plastic or other material that is formed around at least a portion of busbar segments 605 using insert molding or other suitable techniques such as, but not limited to, an edge grommet or edge coating. The overmolded tray segments may facilitate locating the busbar segments by including apertures as discussed above to seat about second battery cell terminals, while incorporating the busbar segments to limit assembly steps. Additionally, the overmolded segments may provide an outer structure allowing an optional cover to be fit about the overmolded part and over the busbar segment. Overmolded portions 610 may facilitate the locking together and/or alignment of overmolded busbar segments 605 with one another and/or with the battery pack structure. Any number of additional tray designs may be used according to embodiments of the present technology to accurately place busbar segments, and otherwise facilitate battery pack or segment assembly.

Turning to FIG. 7 is shown a schematic isometric view of a busbar segment structure 700 of a battery pack according to some embodiments of the present technology. The busbar segment may include any feature, aspect, or material previously described, and may be included in any battery pack or structure discussed above. For example, the busbar segment may include a first terminal pad 705 and a second terminal pad 710, which may provide adequate space for welding or joining the busbar segment with the battery terminals. Additionally, as illustrated, an aperture 712 may be formed through one or both of the first terminal pad 705 and/or the second terminal pad 710. This may facilitate locating the battery cell terminals, and ensuring accuracy of the coupling location between the components. In some embodiments, busbar segments may include an additional tab 713, which may provide a surface for coupling one or more sensors, such as voltage, current, temperature, or any other sensing component that may provide operational information for the battery cells or pack.

As explained above, each busbar segment may include one or more flexible sections 715a, 715b. The one or more flexible sections 715a, 715b may be characterized by a bend formed by a portion of the busbar segment, and protruding from a top surface of the busbar, as illustrated. In some embodiments, as illustrated, each flexible section 715a, 715b may extend in a direction oriented away from the battery cell, which may limit or prevent any interaction between battery cell terminals, one or more of which may protrude from a surface of the battery cell. Busbar segment structure 700 may illustrate an additional embodiment of busbar segments according to some embodiments of the present technology, which may form the flexible sections to maximize the amount of the flexible section that is in line with the compression operation. For example, as illustrated previously, busbar segment 330 (see FIG. 3D) may include a flexible section 345 that may angle away from a vertical or lateral direction along the first surface of the battery cells. Accordingly, when compression occurs as illustrated in earlier figures in a direction normal to a direction along the first surface of the battery cells, flexible section 345 may compress with a greater moment of force in multiple directions, such as an x-component, parallel to the direction of compression, as well as a y-component, parallel to a direction along the first surface of the battery cells, and normal to the direction of compression. This may be due in part to the flexible section being angled relative to the direction of compression, which may cause additional material stress on the busbar segment.

Busbar segment structure 700 illustrates a configuration in which flexible sections 715a, 715b may be substantially or essentially aligned or oriented, such as within manufacturing and placement tolerances, with an axis along the first surface of the battery cells or in a direction parallel to a direction across the first surface of the battery cells. This may reduce or minimize a y-component of the moment of force applied on the flexible section during compression in the x-direction. Because the flexible sections 715a, 715b may not be angled, the compression along the flexible section may be more uniform.

Busbar segment structure 700 also illustrates the incorporation of multiple flexible sections 715a, 715b between the first terminal pad and the second terminal pad. When a single flexible section is utilized, depending on the spacing between cells, a smaller flexible section may be used, which may reduce the amount of compression available. By including separate flexible sections, each section may be offset further from one of the terminal pads, which may allow a larger flexible section without interfering with welds or other coupling. This may afford a greater amount of deflection during compression operations. A gap 720a may be formed between the two flexible sections 715a, 715b, which may allow the sections to be offset laterally from one another, and be mechanically decoupled from one another, as illustrated. Gap 720a may include reliefs 725a at either end that may be radiused to minimize stress concentration between flexible section 715b and first terminal pad 705 during compression. Similarly gap 720b may be formed between flexible section 715b and second terminal pad 710 and may include relief 725b to minimize stress concentration between flexible section 715b and second terminal pad 710 during compression.

By incorporating multiple flexible sections, and by orienting the flexible sections along the first surface of the battery cells, or normal to a direction of compression, embodiments of the present technology may afford a greater amount of compression to be accommodated, while minimizing an amount of stress at weld or coupling locations between the busbar segments and the battery cell terminals. In some embodiments more than two flexible sections 715a, 715 can be disposed between first terminal pad 705 and/or the second terminal pad 710. In some embodiments flexible sections 715a, 715b may have an arcuate cross-section that extends above a top surface of first terminal pad 705 and/or the second terminal pad 710 by a distance between one thickness of buss bar segment and two thicknesses of buss bar segment or between one thickness of buss bar segment and three thicknesses of buss bar segment. In further embodiments flexible sections 715a, 715b may have semicircular cross-sections c-shaped cross-sections, v-shaped cross-sections, channel-shaped cross-sections or any other suitable cross-section. In some embodiments instead of flexible sections 715a, 715b having only one arcuate deformation each, they may have a series of two, three, for or more deformations in series, each which may provide additional stress relief during battery compression (e.g., a reduction in elastic modulus). In yet further embodiments flexible sections 715a, 715b may be narrower than illustrated in FIG. 2 such that three, four, five, six, seven, or eight or more flexible sections can be disposed between first terminal pad 705 and second terminal pad 710.

In some embodiments busbar segment structure 700 can be made from any suitable electrically conductive material. In one embodiment, busbar segment structure 700 is made from a plurality of layers of metal and is approximately 2 mm thick. In some embodiments the number layers of metal are two or more layers, three or more layers, five or more layers, ten or more layers, twenty or more layers or thirty or more layers. Each layer of the plurality of layers may have a thickness less than 2 mm, less than 1 mm, less than 0.5 mm, less than 0.3 mm less than 0.15 mm, less than 1 mm or less than 0.075 mm. In one embodiment one or more layers of the plurality of layers may have a thickness that is greater than or less than the other layers. In various embodiments the electrically conductive material is aluminum, copper, steel, an alloy of two or more metals or any other suitable electrically conductive material.

In some embodiments the thickness of busbar segment structure is between 0.5 mm and 10 mm, between 1 mm and 5 mm, between 1.8 mm and 3 mm and in one embodiment is approximately 2 mm. In various embodiments busbar segment structure 700 is made from a solid homogeneous material such as a 0.2 mm thick aluminum plate. In embodiments where busbar segment structure 700 is made from a plurality of layers of metal the plurality of layers of metal may be decoupled from one another allowing relative motion between each layer to reduce stress applied to the battery terminals during compression of the battery stack. The plurality of layers therefore may reduce a modulus of elasticity of busbar segment structure 700 while having substantially the same electrical resistance as a solid busbar segment of the same thickness.

In some embodiments in which busbar segment structure 700 is made from a plurality of layers of metal, after first terminal pad 705 and second terminal pad 710 are welded to respective battery terminals, the first terminal pad and the second terminal pad may each have regions where each of the plurality of metal layers are fused together. This regionalized fusing of the layers may provide increased reliability to the joint formed between the battery terminals and the busbar segment and may also enable current to be efficiently transferred between the battery terminal and each metal layer that forms the busbar segment to minimize electrical resistance. In some embodiments the regionalized fusing may only be performed in the first terminal pad and the second terminal pad regions such that the plurality of metal layers are not fused in flexible sections 715a, 715b so the plurality of metal layers can move relative to each other to reduce stress during compression of the battery pack. In further embodiments all cross-hatched regions shown in FIG. 7 may have fused layers such that the plurality of layers are attached to one another in those regions so there is no relative motion between each of the regions, however, as shown, flexible sections 715a, 715b may have separation between each of the plurality of layers to allow each layer to move relative to the other layers. In some embodiments the plurality of metal layers are diffusion bonded together under applied compressive pressure and/or elevated temperature, while in other embodiments the layers can be welded together, soldered or brazed together, mechanically fastened together or secured together via any other suitable process.

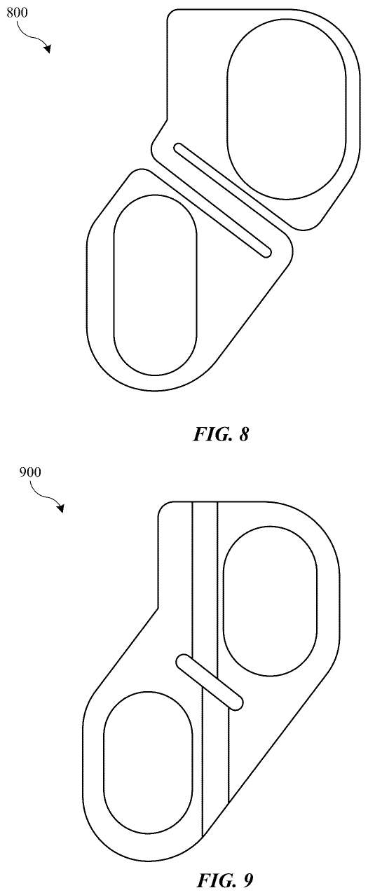

FIG. 8 shows a schematic view of a busbar segment structure 800 of a battery pack according to some embodiments of the present technology. The busbar segment may include any feature, aspect, or material previously described, and may be included in any battery pack or structure discussed above. To reduce a protrusion along the busbar, which may interfere with surrounding components, or increase overall pack dimensions, busbar segment structure 800 may illustrate an additional configuration of a flexible section 805, which may extend partially or fully across a busbar segment. For example, flexible section 805 may operate as a flexible span, allowing each end of the flexible section to accommodate compression to limit stress on the terminal pad portions of the busbar segment.

FIG. 9 shows a schematic view of a busbar segment structure 900 of a battery pack according to some embodiments of the present technology. The busbar segment may include any feature, aspect, or material previously described, and may be included in any battery pack or structure discussed above. Similar to busbar segment structure 700, busbar segment structure 900 may include multiple flexible sections oriented to minimize a y-component of a moment of force when compression is applied in an x-direction. Busbar segment structure 900 illustrates increased flexible sections, which may help to distribute the compression and limit an impact on weld or coupling locations between the busbar segment and the battery cell terminals. By utilizing busbar components and structures according to embodiments of the present technology, battery cell stacks may be compressed during assembly without compromising electrical connections across the battery cells.

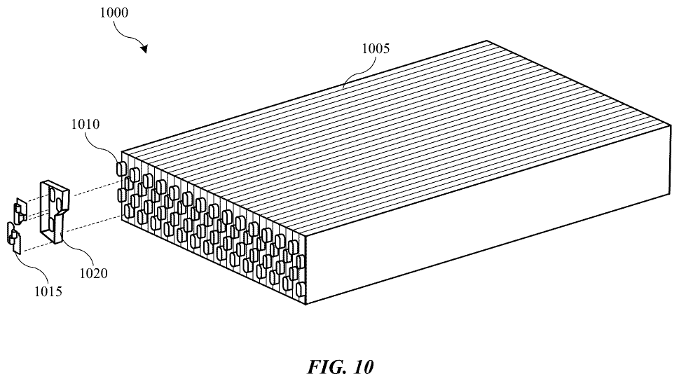

FIG. 10 shows a simplified isometric view of a battery pack 1000 according to some embodiments of the present technology. Battery pack 1000 includes a number of battery cells 1005 distributed in rows and may have similar features as battery pack 100 in FIG. 1. Each battery cell 1005 may include one or more electrical terminals 1010 that are electrically coupled together via busbar segment structures 1015. Busbar segment structures may be disposed in bus trays 1020 that may hold busbar segment structures in place and locate busbar segment structures over electrical terminals 1010 so busbar segment structures can be attached (e.g., laser welded) to the electrical terminals. Busbar segment structure 1015 and busbar trays 1020 may include any feature, aspect, or material described herein, and may be included in any battery pack or structure discussed herein.

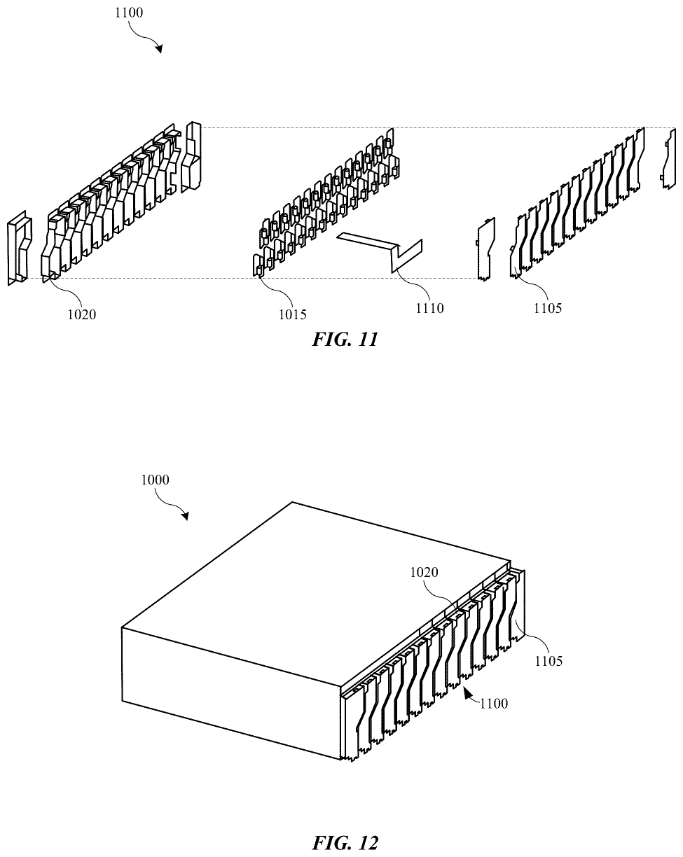

FIG. 11 shows a simplified isometric view of a busbar assembly 1100 according to some embodiments of the present technology. Busbar assembly 1100 includes a plurality of busbar segment structures 1015 that can be received within a corresponding plurality of busbar trays 1020. In some embodiments busbar segment structures 1015 can be retained within corresponding busbar trays 1020 via one or more snap features, bonding, laser welding, ultrasonic welding or other suitable process. A plurality of busbar tray covers 1105 are fit over plurality of busbar trays 1020 to enclose plurality of busbar tray segment structures 1015 in a non-electrically conductive shell. Busbar tray covers 1105 may be coupled to corresponding busbar trays via snap features, laser welding, bonding, ultrasonic welding or any other suitable process. As described above, in some embodiments busbar trays 1020 may align busbar segment structures 1015 on electrical terminals (see FIG. 10) of each respective battery cell so the busbar segment structures can be attached (e.g., laser welded, bolted, bonded) to the electrical terminals. In some embodiments each busbar segment structure 1015 may be used to connect battery cells (see FIG. 10) in series where each busbar segment structure couples a positive terminal of a first battery cell with a negative terminal of an adjacent battery cell so the battery cells are connected in series. In further embodiments each busbar segment structure couples a positive terminal of a first battery with a positive terminal of an adjacent battery so the battery cells are connected in parallel. A battery pack may include any combination of series and parallel connected cells.

Busbar segment structures 1015 may also enable battery pack (see FIG. 10) to be compressed during which busbar trays 1020 maintain electrical isolation and alignment of the busbar segment structures. Busbar tray covers 1105 may enable electrically conductive busbar segment structures 1015 to be insulated from the environment within an electrically insulative enclosure for safety and/or contamination protection. As shown in FIG. 11 some embodiments may include one or more battery pack busbars 1110 that may provide electrical connections to the battery pack. Battery pack busbars 111—may have one or more specialized trays 1020 and/or battery pack busbar covers. In some embodiments, by optimizing busbar segment structures 1015 to deflect easily (e.g., low elastic modulus) in the battery cell stack compression direction, and by reducing the number of or adapting the busbar trays 1020, the forces applied to the battery cell terminals during compression can be reduced. The fully assembled busbar tray assembly can also be touch safe while also retaining the positive/negative battery pack busbars until final installation. Busbar segment structures 1015, busbar trays 1020 and busbar tray covers 1105 may include any feature, aspect, or material described herein, and may be included in any battery pack or structure discussed herein.

FIG. 12 shows a simplified isometric view of battery pack 1000 with a fully assembled busbar assembly 1100, according to some embodiments of the present technology. Busbar assembly 1100 is illustrated with busbar tray covers 1105 assembled on busbar trays 1020 to provide electrical insulation around the electrical connections to each battery cell. Battery pack busbar covers are disposed over battery pack busbars 1115 (see FIG. 11) to similarly provide electrical insulation around the electrical connections. Battery pack 1000 is shown in a compressed state where the cells are compressed and busbar trays 1020 are aligned adjacent and proximate one another. Busbar segment structures 1015, busbar trays 1020, busbar tray covers 1105 and battery pack 1000 may include any feature, aspect, or material described herein, and may be included in any battery pack or structure discussed herein.

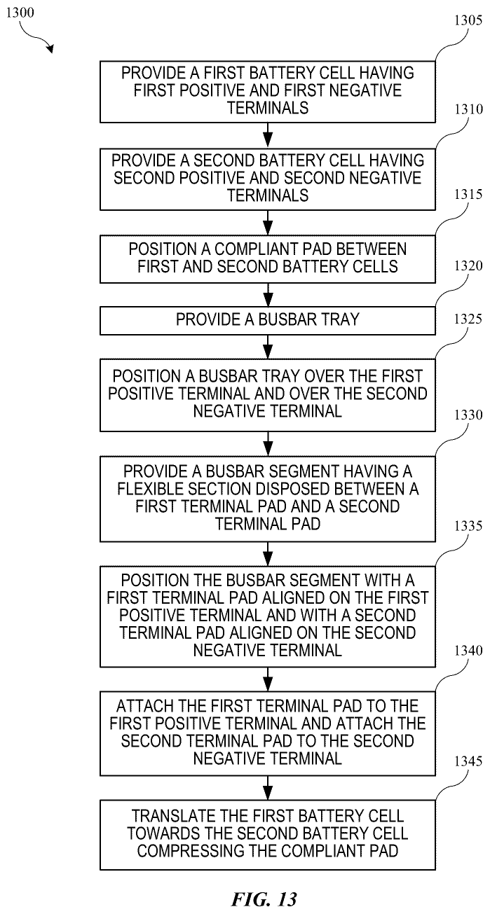

FIG. 13 illustrates steps associated with a method 1300 forming a battery pack, according embodiments of the disclosure. Method 1300 may include any feature, aspect, or material described herein, and may be included in any battery pack or structure discussed herein.

In step 1305 a first battery cell having a first positive and a first negative terminal is provided. In some embodiments the first battery cell may have a shape and configuration as shown in FIG. 10 (battery cells 1005) however the first battery cell may have any other suitable configuration. The first battery cell may have a first positive and a first negative terminal (terminal 1010) as also shown in FIG. 10, however the first battery cell may have any other suitable configuration.

In step 1310 a second battery cell having a second positive and a second negative terminal is provided. In some embodiments the second battery cell may have a shape and configuration as shown in FIG. 10 (battery cells 1005) however the second battery cell may have any other suitable configuration. The second battery cell may have a second positive and a second negative terminal (terminal 1010) as also shown in FIG. 10, however the second battery cell may have any other suitable configuration.

In step 1315 a compliant pad is positioned between the first and the second battery cells. In some embodiments the compliant pad may have a shape and configuration as shown and described in FIG. 1 (compliant pad 150) however the compliant pad may have any other suitable configuration.

In step 1320 a busbar tray is provided. In some embodiments the busbar tray is made from an electrically insulative material and is arranged to receive a busbar segment, as described herein. In various embodiments the busbar tray may have a shape and configuration as shown in FIG. 10 (busbar tray 1020) with apertures configured to receive at least one terminal of the first battery cell and at least one terminal of the second battery cell, however the busbar tray may have any other suitable configuration.

In step 1325 the busbar tray is positioned over the first positive terminal of the first battery cell and over the second negative terminal of the second battery cell. As described herein, in some embodiments the busbar tray may have apertures configured to receive one or more of the battery cell terminals such that the battery cell terminals extend within a cavity formed by the busbar tray, however the busbar trays may have any other suitable configuration.

In step 1330 a busbar segment is provided and includes a flexible section disposed between a first terminal pad and a second terminal pad. In some embodiments the busbar segment may have a configuration as shown in FIG. 10 (busbar segment 1015) however the busbar segment may have any other suitable configuration.

In step 1335 the busbar segment is positioned such that the first terminal pad is disposed on the first positive terminal and the second terminal pad is aligned on the second negative terminal as shown, for example, in FIG. 10. However, the busbar segment may be aligned on the battery cell terminals in any other suitable configuration.

In step 1340 the first terminal pad is attached to the first positive terminal and the second terminal pad is attached to the second negative terminal. In some embodiments the attachment may be performed via laser welding, soldering, brazing, adhesive, mechanical fastener or any other suitable method.

In step 1345 the first battery cell is translated (e.g., moved horizontally) towards the second battery cell such that the compliant pad is compressed between the first and the second battery cells. Therefore, in some embodiments the battery pack has a first state where the pad is uncompressed and a second state where the pad is compressed. This results in a first state with a first gap between the first and second battery cells and a second state with a second gap between the battery cells wherein the second gap is smaller than the first gap. During the compression the flexible segment of the busbar segment may accommodate the movement (e.g., translation of the first battery cell towards the second battery cell) without applying large forces on the battery terminals.

It will be appreciated that method 1300 is illustrative and that variations and modifications are possible. Steps described as sequential may be executed in parallel, order of steps may be varied, and steps may be modified, combined, added or omitted.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery pack comprising:
a first end beam;
a second end beam;
a plurality of battery cells disposed between the first end beam and the second end beam, wherein each battery cell of the plurality of battery cells is separated from an adjacent battery cell by an insulation material, and wherein each battery cell of the plurality of battery cells includes a first terminal and a second terminal on a first surface of the battery cell;
a plurality of busbar segments electrically coupling each battery cell of the plurality of battery cells; and
a bus tray comprising a plurality of bus tray segments, wherein each bus tray segment seats at least two busbar segments, and wherein each bus tray segment extends at least partially across at least three battery cells of the plurality of battery cells.

2. The battery pack of claim 1, wherein each bus tray segment seats a first busbar segment electrically coupling the first terminal of a first battery cell with the second terminal of a second battery cell, and wherein each bus tray segment further seats a second busbar segment electrically coupling the first terminal of the second battery cell with a second terminal of a third battery cell.

3. The battery pack of claim 2, wherein each battery cell of the plurality of battery cells is inverted along the first surface relative to an adjacent battery cell.

4. The battery pack of claim 1, wherein each bus tray segment is at least partially separated from an adjacent bus tray segment by a gap.

5. The battery pack of claim 4, wherein each bus tray segment is coupled with an adjacent bus tray segment across the gap by an arcuate connector.

6. The battery pack of claim 4, wherein each bus tray segment at least partially overlaps an adjacent bus tray segment.

7. The battery pack of claim 6, wherein each bus tray segment defines an aperture for each terminal over which the bus tray segment is positioned.

8. The battery pack of claim 7, wherein each second terminal protrudes from the first surface of an associated battery cell, and wherein each bus tray segment comprises a tab at each aperture associated with a second terminal, the tab configured to seat the bus tray segment about each associated second terminal.

9. The battery pack of claim 1, wherein each busbar segment comprises a first terminal pad and a second terminal pad, and wherein an aperture is defined through at least one of the first terminal pad and the second terminal pad.

10. The battery pack of claim 9, wherein each busbar segment comprises a flexible section characterized by a bend defined by the busbar segment and protruding from a surface of the busbar segment opposite a surface facing the plurality of battery cells.

11. The battery pack of claim 10, wherein each busbar segment comprises two flexible sections separated by a break through the busbar segment.

12. The battery pack of claim 11, wherein the two flexible sections are laterally offset from each other.

13. The battery pack of claim 11, wherein the two flexible sections are each oriented in a direction parallel to the first surface of a battery cell of the plurality of battery cells.

14. A battery pack comprising:
a first end beam;
a second end beam;
a first side beam extending between the first end beam and the second end beam;
a second side beam extending between the first end beam and the second end beam;
a base, wherein the first end beam, the second end beam, the first side beam, the second side beam, and the base are welded along each interface between each component;
a plurality of battery cells disposed between the first side beam and the second side beam, wherein each battery cell of the plurality of battery cells is separated from an adjacent battery cell by an insulation material, and wherein each battery cell of the plurality of battery cells includes a first terminal and a second terminal on a first surface of the battery cell;
a plurality of busbar segments electrically coupling each battery cell of the plurality of battery cells;
a bus tray comprising a plurality of bus tray segments, wherein each bus tray segment seats at least two busbar segments, and wherein each bus tray segment extends at least partially across at least three battery cells of the plurality of battery cells; and
a lid coupled with a surface of each battery cell of the plurality of battery cells facing the lid.

15. The battery pack of claim 14, further comprising:
a longitudinal beam extending between the first end beam and the second end beam, wherein the longitudinal beam is disposed between the first side beam and the second side beam.

16. The battery pack of claim 15, wherein the plurality of battery cells comprise a first plurality of battery cells, and wherein the battery pack further comprises:
a second plurality of battery cells disposed between the second side beam and the longitudinal beam, wherein each battery cell of the second plurality of battery cells is separated from an adjacent cell by an insulation material.

17. The battery pack of claim 16, wherein the longitudinal beam is characterized by a first longitudinal surface and a second longitudinal surface opposite the first longitudinal surface, wherein the first surface of each battery cell of the first plurality of battery cells faces the first longitudinal surface of the longitudinal beam, and wherein the first surface of each battery cell of the second plurality of battery cells faces the second longitudinal surface of the longitudinal beam.

18. The battery pack of claim 14, wherein each bus tray segment seats a first busbar segment electrically coupling the first terminal of a first battery cell with the second terminal of a second battery cell, and wherein each bus tray segment further seats a second busbar segment electrically coupling the first terminal of the second battery cell with a second terminal of a third battery cell.

19. The battery pack of claim 18, wherein each bus tray segment is at least partially separated from an adjacent bus tray segment by a gap.

20. A battery pack comprising:
a first end beam;
a second end beam;
a first side beam extending between the first end beam and the second end beam;
a second side beam extending between the first end beam and the second end beam;
a base;
a plurality of battery cells disposed between the first side beam and the second side beam, wherein each battery cell of the plurality of battery cells is separated from an adjacent battery cell by an insulation material, and wherein each battery cell of the plurality of battery cells includes a first terminal and a second terminal on a first surface of the battery cell, wherein the first end beam and the second end beam maintain the plurality of battery cells compressed between the first end beam and the second end beam;
a plurality of busbar segments electrically coupling each battery cell of the plurality of battery cells;
a bus tray comprising a plurality of bus tray segments, wherein each bus tray segment seats at least two busbar segments, and wherein each bus tray segment extends at least partially across at least three battery cells of the plurality of battery cells; and
a lid coupled with a surface of each battery cell of the plurality of battery cells facing the lid.
